(19) United States
(12) Patent Application Publication
(10) Pub. No.: US 2002/0182307 A1
(43) Pub. Date: Dec. 5, 2002

(54) Organic electroluminescent devices with organic layers deposited at elevated substrate temperatures

(75) Inventors: Shuit-Tong Lee, Kowloon (HK); Chun-Sing Lee, Kowloon (HK); Zhi-Qiang Gao, Kowloon Tong (HK)

Correspondence Address: MERCHANT & GOULD PC, P.O. BOX 2903, MINNEAPOLIS, MN, 55402-0903, US

(73) Assignee: City University of Hong Kong, Kowloon (HK)

(21) Appl. No.: 10/163,442

(22) Filed: Jun. 4, 2002

Related U.S. Application Data
(62) Division of application No. 09/250,933, filed on Feb. 18, 1999.

(51) Int. Cl. H05B 33/10; H05B 33/12

(52) U.S. Cl. 427/66; 428/690; 428/917; 313/504; 313/506

(57) ABSTRACT

An organic light-emitting diode has been disclosed, in which crystalline organic films were utilized to increase device stability upon operation. Correspondingly, a novel method has been developed to improve device performance through depositing organic electroluminescent materials at elevated substrate temperatures. The improvements are attributed to the formation of crystalline films or amorphous films with a better short range order.

### FIELD OF THE INVENTION

This invention relates to organic electroluminescent (EL) devices. More particularly, this invention relates to the use of organic crystalline flms deposited at elevated substrate temperatures for device fabrication.

### BACKGROUND OF THE INVENTION

Since Tang and Vanslyke made the first multi-layer organic light-emitting diode by vacuum deposition of organic thin films at room temperature (see Appl. Phys. Lett. Vol. 51, 1987, P. 913), there has been considerable interest in the use of organic materials for fabrication of organic light-emitting diodes (LEDs). As a result, more and more new materials and processing technologies have been developed to improve the performance of the organic LEDs. Together with their wide viewing angle, high contrast, high brightness, and potentially low production cost, organic LEDs have a good potential for large-area flat panel display applications.

In a basic organic LED structure, one organic layer is specifically chosen to inject and transport holes and the other organic layer is specifically chosen to inject and transport electrons. The interface between the two layers provides an efficient site for the recombination of the injected hole-electron pair and resultant electroluminescence. The simple structure can be modified to a three-layer structure, in which an additional luminescent layer is introduced between the hole and electron transporting layers to function primarily as the site for hole-electron recombination and thus electroluminescence. In this respect, the functions of the individual organic layers are distinct and can therefore be optimized independently. Thus, the luminescent or recombination layer can be chosen to have a desirable EL color as well as a high luminance efficiency. Likewise, the electron and hole transport layers can be optimized primarily for the carrier transport property. Recently devices have been made with various configurations by inserting additional organic or inorganic interlayers between electrodes and carry-transport layers to enhance carrier-injection or improve device operational stability.

In order to achieve the best device performance, the organic materials are required to have excellent thin film formation properties. Thermal evaporation in vacuum at room temperature is a conventional method to deposit pin-hole free organic thin films. However, the resulting films are generally amorphous and presumably contain a considerable amount of defects. These defects might serve as trap sites to capture injected carries and thus reduce electron-hole recombination (see Appl. Phys. Lett. Vol. 73, 1998, P. 1457) or function as non-radiative centers to quench light emission (see Phys. Rev. Lett. Vol. 78, 1997, P. 3955).

Long-term stability is one of the critical issues for the commercial applications of organic LEDs. Several mechanisms have been suggested to account for the device degradation upon operation or storage. Crystallization of organic thin films and interdiffusion between different organic layers are among the most reported degradation mechanisms (see Mol. Cryst. Liq. Cryst. Vol. 253, 1994, P. 143 and Appl. Phys. Lett. Vol. 68, 1996, P. 1787). The amorphous to crystalline phase transformation in organic thin films are generally believed to result in physical and morphological changes and progressively reduce light emission.

Several methods have been employed to retard the crystallization process in organic thin films. Mori et al. used plasma polymerization to suppress the crystallization of their hole-transport medium (see Jpn. J. Appl. Phys. Vol. 34, 1995, P. L586). No beneficial effects were observed on the device stability as only the top surface of the hole-transport layer could be modified. The other approach is to use a hole-transport material with a high glass-transition temperature (Tg) (see Appl. Phys. Lett. Vol. 69, 1996, P. 878), however, this makes it difficult to synthesize a material having all the required properties.

### SUMMARY OF INVENTION

It is an object of the present invention to provide an organic LED in which at least one organic layer is not amorphous.

It is another object of the present invention to provide a method to improve the performance of an organic LED by depositing organic thin films at elevated substrate temperatures.

According to the present invention there is provided an organic light-emitting diode comprising:

a) a substrate formed of an electrically insulating material;

b) a conductive anode formed on the substrate;

c) an organic light-emitting structure formed on the anode and which contains at least one crystalline organic layer; and

d) a cathode formed over the organic light-emitting structure.

The use of crystalline organic thin films in organic LEDs eliminates the amorphous-crystalline phase transformation upon operation or storage and thus increases the device stability. The hot substrate deposition at elevated temperatures either produces a crystallized organic film or generates an amorphous film having a better short range order. As a result, both electrical and optical characteristics of the organic LEDs can be improved significantly.

The substrate may be optically transparent (eg plastics or glass) or may be opaque (eg ceramic or a semiconductor material). The conductive anode may be transmissive and may be selected from the group consisting of a metal oxide (eg indium-tin oxide, aluminium- or indium-doped zinc oxide, tin oxide, magnesium-indium oxide, nickel-tungsten oxide, and cadmium-tin oxide), gallium nitride, zinc selenide, and zinc sulphide. Alternatively the conductive anode may be opaque and may be selected from the group consisting of a metal (eg gold, iridium, palladium and platinum) and a metallic compound having a work function greater than 4.1 eV.

Preferably the light-emitting structure includes

(i) an organic hole-transporting layer formed over the anode layer;

(ii) an organic light-emitting layer formed over the hole-transporting layer; and

(iii) an organic electron-transporting layer formed over the light-emitting layer.

The organic hole-transporting layer may be formed of a material including hole-transporting aromatic tertiary amine molecules. The organic light-emitting layer may be formed of a light-emitting host material selected from the group consisting of metal chelated oxinoid compounds. The light-emitting layer may also include at least one dye capable of emitting light when dispersed in the light-emitting host material.

The electron-transporting layer is formed of a material selected from the group consisting of metal chelated oxinoid compounds.

According to another aspect of the present invention there is provided a method of making an organic light-emitting diode, comprising the steps of:

a) providing a substrate;

b) depositing an anode over the substrate;

c) sequentially forming an organic light-emitting structure over the anode at elevated substrate temperatures in a vacuum system equipped with a substrate heater; and

d) depositing a cathode layer over the organic light-emitting structure.

Preferably the light-emitting structure comprises (i) an organic hole-transporting layer formed over the anode layer; (ii) an organic light-emitting layer formed over the hole-transporting layer; and (iii) an organic electron-transporting layer formed over the light-emitting layer.

The emissive layer may be formed as part of the hole-transport layer or may be a part of the electron-transport layer, or may be a separate layer.

The substrate is preferably selected from the group including ITO-coated glass and ITO-coated plastic foils.

At least one organic layer of the light-emitting structure is deposited at an elevated temperature, but in some embodiments the entire organic light-emitting layer may be formed at elevated temperatures. Preferred temperature ranges are from 50° C. to 400° C., more preferably still from 80° C. to 200° C. The substrate heater may be of any suitable form, for example a resistive heater, inductive heater or an infra-red heater.

### BRIEF DESCRIPTION OF THE DRAWINGS

Some embodiments of the present invention will now be described by way of example and with reference to the accompanying drawings, in which:—

FIG. 1 is a schematic diagram of an embodiment of the organic LEDs in accordance with the present invention;

FIG. 2 is a schematic diagram of a deposition system used in embodiments of this invention for hot substrate deposition;

FIG. 3 is a plot showing the luminance-current-voltage characteristics of the organic LED in Example 1;

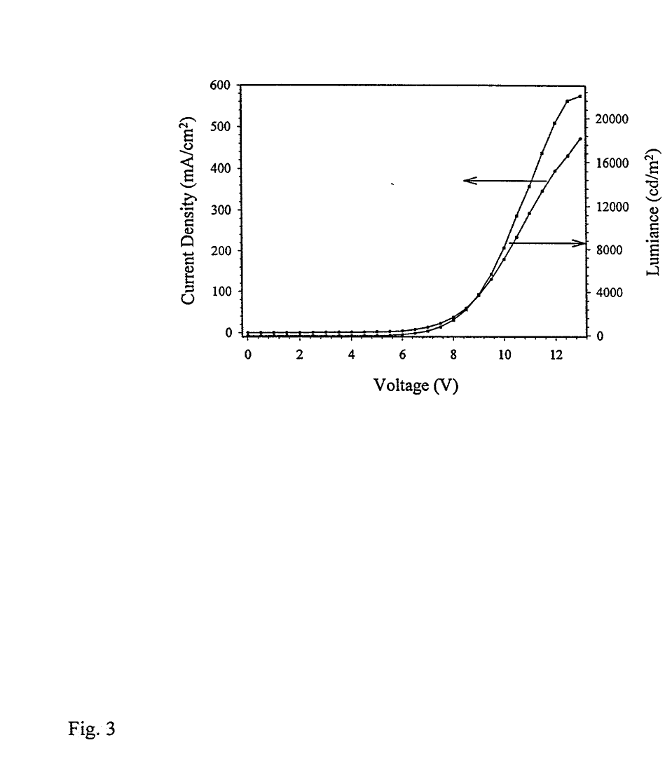

FIG. 4 is a plot showing the luminance-current-voltage characteristics of the organic LED in Example 2;

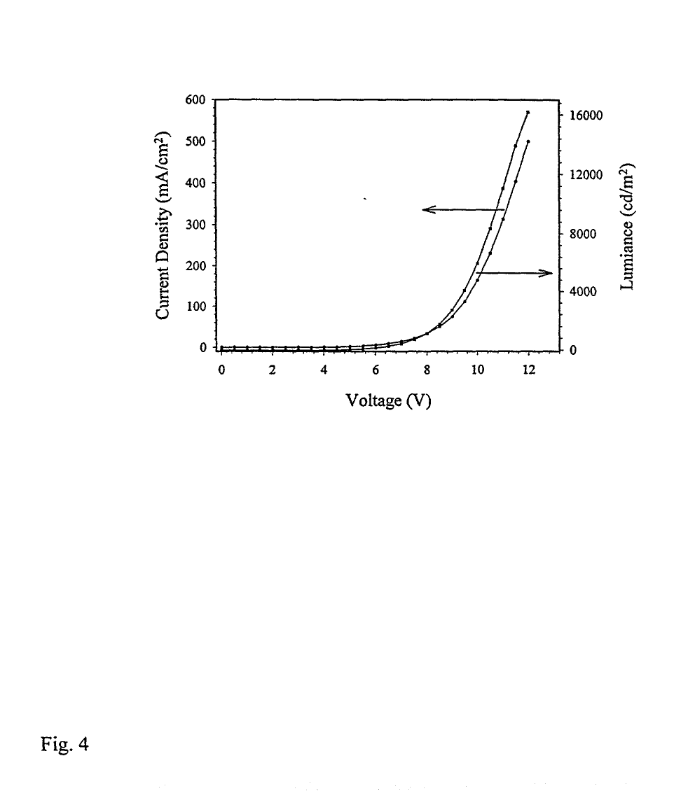

FIG. 5 is a plot showing the luminance-current-voltage characteristics of the organic LED in Example 3;

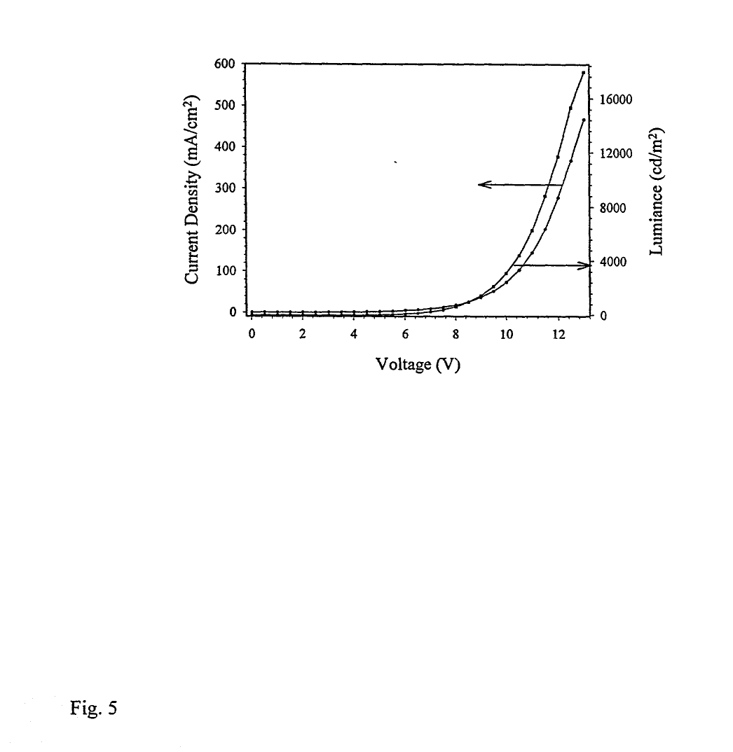

FIG. 6 are Raman spectra taken from (a) NPB crystalline powders and (b) a NPB film deposited at 140° C.

### DESCRIPTION OF THE PREFERRED EMBODIMENTS

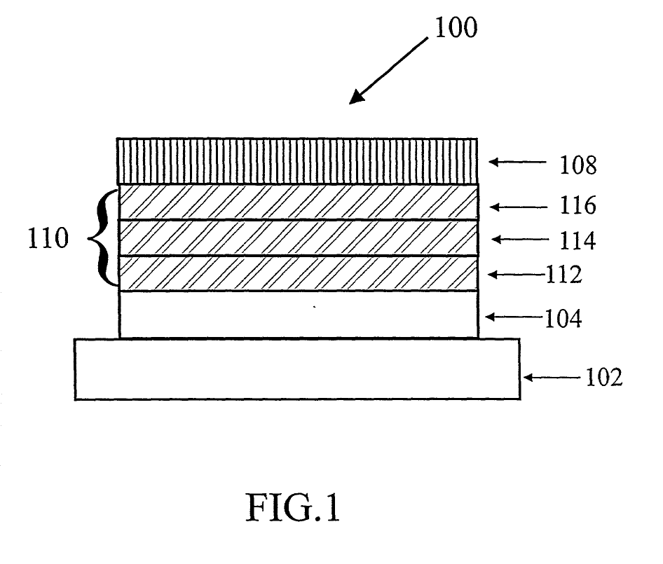

Turning to FIG. 1, an organic light-emitting device 100 has a substrate 102 on which is disposed an anode 104. An organic light-emitting structure 110 is formed between the anode 104 and a cathode 108. The organic light-emitting structure 110 is comprised of, in sequence, an organic hole-transporting layer 112, an organic light-emitting layer 114, and an organic electron-transporting layer 116. When an electrical potential difference (not shown) is applied between the anode 104 and the cathode 108, the cathode will inject electrons into the electron-transporting layer 116, and the electrons will traverse the electron-transporting layer 116 and the light-emitting layer 114. At the same time, holes will be injected from the anode 104 into the hole-transporting layer 112. The holes will migrate across layer 112 and recombine with electrons in the light-emitting layer 114. As a result light is emitted from the organic LED.

The substrate 102 is electrically insulated and can either be light transmissive or opaque. The light transmissive property of a glass substrate or a plastic foil is desirable for viewing the EL emission through the substrate. For applications where the EL emission is viewed through the top electrode, the transmissive characteristic of the support is immaterial, and therefore any appropriate substrate such as an opaque semiconductor or a ceramic wafers can be used. Of course, it is necessary to provide in these device configurations a light transparent top electrode.

The anode 104 is formed of a conductive and transmissive layer. The light transparent property of the layer 104 is desirable for viewing the EL emission through the substrate. For applications where the EL emission is viewed through the top electrode, the transmissive characteristic of the layer 104 is immaterial, and therefore any appropriate materials such as metals or metal compounds having a work function greater than 4.1 eV can be used. The metal includes gold, iridium, molybdenum, palladium, and platinum. The conductive and transmissive layer can be selected from the group of metal oxides, nitrides such as gallium nitride, selenides such as zinc selenide, and sulphides such as zinc sulphide. The suitable metal oxides include indium-tin oxide, aluminum- or indium-doped zinc oxide, tin oxide, magnesium-indium oxide, nickel-tungsten oxide, and cadmium-tin oxide.

The hole transporting layer of the organic EL device contains at least one hole transporting aromatic tertiary amine, where the latter is understood to be a compound containing at least one trivalent nitrogen atom that is bonded only to carbon atoms, at least one of which is a member of an aromatic ring. In one form the aromatic tertiary amine can be an arylamine, such as a monarylamine, diarylamine, triarylamine, or a polymeric arylamine. Exemplary monomeric triarylamines are illustrated by Klupfel et al U.S. Pat. No. 3,180,730. Other suitable triarylamines substituted with vinyl or vinyl radicals and/or containing at least one active hydrogen containing group are disclosed by Brantley et al U.S. Pat. Nos. 3,567,450 and 3,658,520.

The luminescent layer of the organic EL device comprises of a luminescent or fluorescent material, where electroluminescence is produced as a result of electron-hole pair recombination in this region. In the simplest construction, the luminescent layer comprises of a single component, that is a pure material with a high fluorescent efficiency. A well known material is tris (8-quinolinato) aluminum, (Alq), which produces excellent green electroluminescence. A preferred embodiment of the luminescent layer comprises a multi-component material consisting of a host material doped with one or more components of fluorescent dyes. Using this method, highly efficient EL devices can be constructed. Simultaneously, the color of the EL devices can be tuned by using fluorescent dyes of different emission wavelengths in a common host material. This dopant scheme has been described in considerable details for EL devices using Alq as the host material by Tang et al in US. Pat. No. 4,769,292.

Preferred materials for use in forming the electron transporting layer of the organic EL devices of this invention are metal chelated oxinoid compounds, including chelates of oxine itself (also commonly referred to as 8-quinolinol or 8-hydroxyquinoline). Such compounds exhibit both high levels of performance and are readily fabricated in the form of thin layers.

The organic EL devices of this invention can employ a cathode constructed of any metal having a work function lower than 4.0 eV, such as calcium and lithium. The cathode can also be formed through alloying a low work function metal with a high work function metal. A bilayer structure of Al/LiF can also been used to enhance electron injection.

In the prior art, the organic light-emitting structure 110 is constructed by sequential vapor deposition of the hole-transporting layer 112, the light-emitting layer 114, and the electron-transporting layer 116 at room temperature. Thus all the organic layers in organic LEDs are amorphous. In the present invention, at least one of the organic layers is fully crystallized or partly crystallized during deposition, thus reducing the device instability caused by the amorphous-crystalline phase transformation. The thickness of an individual organic layer largely depends on the materials used in organic LEDs and the requirements for potential applications, and it can be varied from 3 to 2,000 nm with a preferred range of 30 to 300 nm.

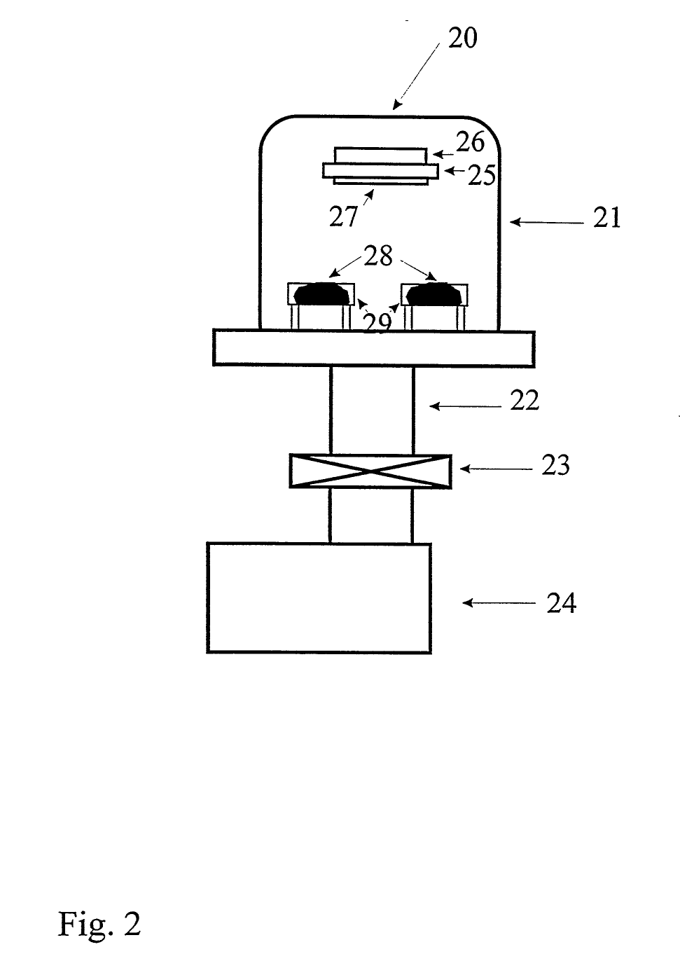

Turning now to FIG. 2, there is shown a schematic diagram of a thermal deposition system 20 used in this invention to prepare an organic LED. The system 20 has a chamber 21. A pump conduit 22 is connected to a pump 24 via a control valve 23. An ITO glass substrate 25 was heated by a resistive heater 26 to a predetermined temperature and held at this temperature for more than 30 minutes before deposition. An organic layer 27 was deposited on the hot substrate by thermal evaporation of a desired organic material 28 from an evaporation boat 29.

The base pressure of the system is lower than 6×10⁻⁷ Pa. The operation pressure is better than 3×10^{31 6} Pa during the deposition of organic materials. However, the pressure has a broad range for hot substrate deposition from 1×10⁻² Pa to 1×10⁻⁹ Pa. In the present invention, the deposition was carried out at temperatures in the range of 140° C. The appropriate temperature is largely dependent on organic materials, and it can be varied from 45 to 450° C. with a preferred range of 70-250° C. In the hot substrate deposition, the structure properties of organic films are not affected by the nature of the heaters, so a variety of heaters can be utilized, including an AC or DC resistive heater, an inductive coupling radio-frequency heater, and an infrared irradiative heater.

### EXAMPLES

The following examples are presented for a further understanding of the invention. For purposes of brevity, the materials and the layers formed therefrom will be abbreviated as given below:

| | |
|---|---|
| ITO | indium tin oxide (anode) |
| NPB | 4,4′-bis-[N-(1-naphthyl)-N-phenylamino]-bi-phenyl (hole- |
| | transporting layer) |
| Alq | tris (8-quinolinolato-N1, 08)-aluminum (electron-transporting |
| | layer; functioning here as a combined light-emitting layer and |
| | electron-transporting layer) |
| MgAg | magnesium:silver at a ratio of 10:1 by volume (cathode) |

### Example 1

a) an ITO-coated glass was ultrasonicated sequentially in a commercial detergent, iso-propanol, ethanol, and methanol, rinsed in deionized water, and then dried in an oven. The substrate was further subjected to a UV-ozone treatment for 5-10 minutes.

b) the substrate was transferred into a deposition chamber from a loading chamber. Then the substrate was heated to 140° C. and held at this temperature for more than 30 minutes before deposition.

c) a 80 nm thick NPB hole-transporting layer was deposited on the ITO layer at 140° C.;

d) a 60 nm thick Alq electron-transporting and light-emitting layer was deposited on the NPB layer at 140° C.;

e) a 200 nm thick MgAg layer was deposited on the Alq layer by co-evaporation from two sources (Mg and Ag) at about 70° C.

The electrical and optical properties of the device were characterized. The threshold voltage (defined as the voltage at which the device emits light with a luminance of 1 cd/m²) was determined to be 4.0 V. The luminance at a current density of 20 mA/cm² was 781 cd/m², and the efficiency was about 1.7 lm/W.

### Example 2 (prior art)

a) an ITO-coated glass was ultrasonicated sequentially in a commercial detergent, iso-propanol, ethanol, and methanol, rinsed in deionized water, and then dried in an oven. The substrate was further subjected to a UV- ozone treatment for 5-10 minutes.

b) the substrate was transferred into a deposition chamber from a loading chamber, and held at room temperature during deposition.

c) a 80 nm thick NPB hole-transporting layer was deposited on the ITO layer at room temperature;

d) a 60 nm thick Alq electron-transporting and light-emitting layer was deposited on the NPB layer at room temperature;

e) a 200 mn thick MgAg layer was deposited on the Alq layer by co-evaporation from two sources (Mg and Ag) at about room temperature.

The electrical and optical properties of the device were characterized. The threshold voltage was determined to be 3.6 V. The luminance at a current density of 20 mA/cm² was 618 cd/m², and the efficiency was about 1.3 lm/W.

### Example 3

a) an ITO-coated glass was ultrasonicated sequentially in a commercial detergent, iso-propanol, ethanol, and methanol, rinsed in deionized water, and then dried in an oven. The substrate was further subjected to a UV- ozone treatment for 5-10 minutes.

b) the substrate was transferred into a deposition chamber from a loading chamber. Then the substrate was heated to 140° C. and held at this temperature for more than 30 minutes before deposition.

c) a 80 nm thick NPB hole-transporting layer was deposited on the ITO layer at 140° C.;

d) a 60 nm thick Alq electron-transporting and light-emitting layer was deposited on the NPB layer at room temperature;

e) a 200 nm thick MgAg layer was deposited on the Alq layer by co-evaporation from two sources (Mg and Ag) at about room temperature.

The electrical and optical properties of the device were characterized. The threshold voltage was determined to be 4.0 V. The luminance at a current density of 20 mA/cm² was 660 cd/m², and the efficiency was about 1.3 lm/W.

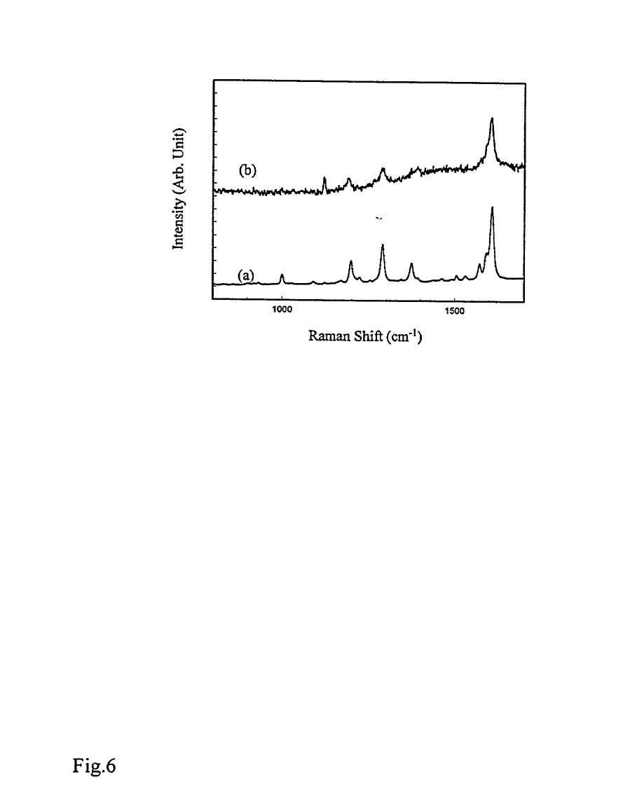

Raman spectra were taken from as-received NPB crystalline powders and from a NPB thin film deposited at 140° C. The spectra showing in FIG. 6 clearly indicate that the NPB film deposited at 140° C. is crystalline.

From the results of Examples 1-3 and the Raman spectra of FIG. 6, it can be seen that when NPB was deposited at 140° C. to form a crystalline film, the luminance efficiency was improved. When both NPB and Alq were deposited at this temperature, an increase in efficiency by 30% was achieved, as compared to the prior art using room temperature deposition.

The storage stability of the organic LEDs was tested without encapsulation. The devices fabricated in Examples 1-3 were stored in air with a humidity of 42% RH for two months. Light emission could be seen from the devices of Examples 1 and 3 at a drive voltage of 9 V, but emission was not visible from the device of Example 2. Apparently, the crystalline state of the hole-transport NPB layers improved the storage stability of the organic LEDs.

The invention has been described in detail with particular reference to certain preferred embodiments thereof, but it will be understood that variations and modifications can be effected within the spirit and scope of the invention. In particular the elevated temperature at which the crystalline layer is deposited may vary depending on the nature of the materials used. Preferably the temperature is within the range 50° C. to 400° C., and more preferably 80° C. to 200° C. It will also be appreciated that the ogranic light emitting structure can take any known form provided that it includes at least one crystalline layer.

What is claimed is:

1. An organic light-emitting diode comprising:
a) a substrate formed of an electrically insulating material;
b) a conductive anode formed on the substrate;
c) an organic light-emitting structure formed on the anode and which contains at least one crystalline organic layer; and
d) a cathode formed over the organic light-emitting structure.

2. The electroluminescent device of claim 1 wherein the substrate is optically transparent and is formed from glass or plastic.

3. The electroluminescent device of claim 1 wherein the substrate is opaque and is formed from a ceramic or semiconducting material.

4. The electroluminescent device of claim 1 wherein the conductive anode is transmissive and is selected from the group consisting of a metal oxide, gallium nitride, zinc selenide, and zinc sulphide.

5. The electroluminescent device of claim 1 wherein the conductive anode is opaque and is selected from the group consisting of a metal and a metallic compound having a work function greater than 4.1 eV.

6. The electroluminescent device of claim 4 wherein the metal oxide includes indium-tin oxide, aluminum- or indium-doped zinc oxide, tin oxide, magnesium-indium oxide, nickel-tungsten oxide, and cadmium-tin oxide.

7. The electroluminescent device of claim 5 wherein the metal includes gold, iridium, palladium, and platinum.

8. The electroluminescent device of claim 1 wherein the organic light-emitting structure includes:
(i) an organic hole-transporting layer formed over the anode layer;
(ii) an organic light-emitting layer formed over the hole-transporting layer; and
(iii) an organic electron-transporting layer formed over the light-emitting layer.

9. The electroluminescent device of claim 8 wherein the organic hole-transporting layer is formed of a material including hole-transporting aromatic tertiary amine molecules.

10. The electroluminescent device of claim 8 wherein the organic light-emitting layer is formed of a light-emitting host material selected from the group consisting of metal chelated oxinoid compounds.

11. The electroluminescent device of claim 8 wherein the organic light-emitting layer further includes at least one dye capable of emitting light when dispersed in the light-emitting host material.

12. The electroluminescent device of claim 8 wherein the electron-transporting layer is formed of a material selected from the group consisting of metal chelated oxinoid compounds.

13. The electroluminescent device of claim 1 wherein the cathode material is selected to have a work function less than 4.0 eV.

14. A method of making an organic light-emitting diode, comprising the steps of:
a) providing a substrate;
b) depositing an anode over the substrate;
c) sequentially forming an organic light-emitting structure over the anode at elevated substrate temperatures in a vacuum system equipped with a substrate heater; and
d) depositing a cathode layer over the organic light-emitting structure.

15. The method of making an organic electroluminescent device of claim 14 wherein the organic light-emitting structure includes:
(i) an organic hole-transporting layer formed over the anode layer;
(ii) an organic light-emitting layer formed over the hole-transporting layer; and
(iii) an organic electron-transporting layer formed over the light-emitting layer.

16. The method of making an organic electroluminescent device of claim 15 wherein the emissive layer is a part of the hole-transport layer or a part of the electron-transport layer.

17. The method of making an organic electroluminescent device of claim 15 wherein the emissive layer is a separated organic layer.

18. The method of making an organic electroluminescent device of claim 14 wherein the substrate is selected from the group including ITO-coated glass and ITO-coated plastic foil.

19. The method of making an organic electroluminescent device of claim 14 wherein the entire organic light-emitting structure is deposited at elevated temperatures.

20. The method of making an organic electroluminescent device of claim 14 wherein at least one organic layer of the organic light-emitting structure is deposited at elevated temperatures.

21. The method of making an organic electroluminescent device of claim 14 wherein the elevated temperature is in the range of 50° C. to 400° C.

22. The method of making an organic electroluminescent device of claim 21 wherein the elevated temperature is in the range of 80° C. to 200° C.

23. The method of making an organic electroluminescent device of claim 14 wherein the thickness of an individual layer in the organic light-emitting structure is in the range of 3 to 300 nm.

24. The method of making an organic electroluminescent device of claim 14 wherein the thickness of an individual layer in the organic light-emitting structure is in the range of 30 to 100 nm.

25. The method of making an organic electroluminescent device of claim 14 wherein the vacuum is in the range of 1×10⁻² to 1×10 ^{31 9} Pa.

26. The method of making an organic electroluminescent device of claim 25 wherein the substrate heater is selected from a group including an AC or DC resistive heater, an inductive coupling radio-frequency heater, and an infrared irradiative heater.
